(19) United States
(12) Patent Application Publication
(10) Pub. No.: US 2011/0131258 A1
(43) Pub. Date: Jun. 2, 2011

(54) Nas-Based Multimedia File Distribution Service

(75) Inventors: Paul Michael Cesario, Fort Collins, CO (US); David H. Hanes, Loveland, CO (US); Charles Martin McJilton, Longmont, CO (US)

(73) Assignee: HEWLETT-PACKARD DEVELOPMENT COMPANY, L.P, Houston, TX (US)

(21) Appl. No.: 13/054,297

(22) PCT Filed: Sep. 30, 2008
(86) PCT No.: PCT/US2008/078279

§ 371 Date: Jan. 14, 2011

(51) Int. Cl. G06F 17/30

(52) U.S. Cl. 707/827; 707/E17.01

(57) ABSTRACT

A network attached storage (NAS) device 104 for multimedia file 110 distribution, the device 104 comprising: a processing device 202; a network interface 106 connected with the processing device 202; and a storage device 210 connected with the processing device 202. The storage device 210 comprising: a set of predetermined multimedia file requests 112; a set of multimedia files 110; and a set of executable instructions 212. The executable instructions 212 cause the processing device 202 to: transmit a request 112 from the set of multimedia file requests 112 to a media server 102 via the network interface 106; receive multimedia files 110 responsive to a transmitted request 112; transmit a multimedia file 110 from the set of multimedia files 110 to a controller 116, 120 via the network interface 106 for display to a user via a display 118, 122 connected with the controller 116, 120; and remove a multimedia file 110 from the set of multimedia files 110 responsive to a predetermined file removal process.

### BACKGROUND

Current video rental and/or distribution systems requires a user to either travel to a retail store to select and rent a video or wait for a video to be delivered in the mail. The hassle of having to travel to the video store or wait for mail decreases the user's satisfaction.

Other pay-per-view solutions allow user's to view videos delivered right to their homes without mail delays using broadcast system such as cable or satellite; however, the video choices are limited and the times to view are determined by the provider.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a high-level block diagram of a multimedia file distribution system usable in conjunction with an embodiment to advantage;

FIG. 2 is a high-level block diagram of a network attached storage device according to an embodiment;

FIG. 3 is an example collection of multimedia file requests according to an embodiment;

FIG. 4 is a high-level functional process flow of a multimedia file request and transmission functionality according to an embodiment; and

FIG. 5 is a high-level functional process flow of a multimedia file registration and transmission functionality according to an embodiment.

### DETAILED DESCRIPTION

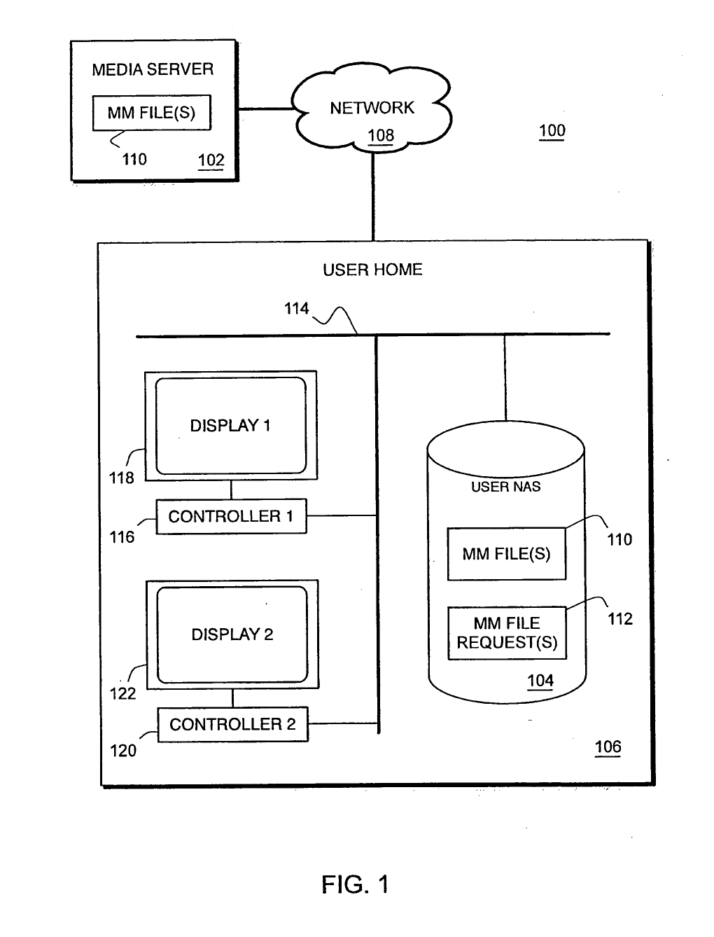

FIG. 1 depicts a high-level block diagram of a multimedia file distribution system 100 usable in conjunction with an embodiment. Distribution system 100 comprises a media server 102 communicatively coupled to a user network attached storage (NAS) device 104 located, for example, in a user's home 106. Network attached storage device 104 may be referred to herein as either NAS 104, NAS device 104, or user NAS device 104. A network 108 connects media server 102 to the user's home 106 and therein to NAS device 104. In at least some embodiments, network 108 may be a wired and/or wireless connection. In at least some embodiments, network 108 may be a transmission control protocol/internet protocol (TCP/IP)-based network. In at least some embodiments, network 108 is the packet-switched network known as the Internet. In at least some embodiments, network 108 may comprise a mobile packet-switched network such as a General Packet Radio Service (GPRS).

In at least some embodiments, multimedia file distribution system 100 may be applied to a context in which NAS device 104 and/or controllers 116, 120 (and corresponding displays 118, 122) are located in a business or retail establishment instead of a user home.

Media server 102 is a computing system comprising memory for storing multimedia files and a set of instructions comprising functionality for communicating with user NAS 104. In at least some embodiments, media server 102 comprises functionality for communicating with a user at a computer system. Media server 102 is arranged to store a plurality of multimedia files 110, e.g., video files such as movies, television shows, audio files such as music albums, tracks, sounds, etc., and multimedia file requests 112. In at least some embodiments, media server 102 comprises functionality for authenticating requests for multimedia files received from NAS 104. In at least some embodiments, media server 102 comprises one or more of billing functionality, cryptographic functionality, authorization functionality, and/or a combination thereof.

In at least some embodiments, one or more multimedia files 110 may be encrypted and/or comprise rights management information for controlling playback on particular devices, e.g., other user devices in user home 106. Multimedia file request 112 comprises a request generated by a user for a predetermined multimedia file from media server 102. In at least some embodiments, multimedia file request 112 comprises an identifier which uniquely identifies a multimedia file stored at media server 102. In at least some embodiments, multimedia file request 112 comprises an attribute of one or more multimedia files stored at media server 102. In at least some embodiments, multimedia file attributes may comprise one or more of a title, a keyword, an author name, an actor/actress name, a director name, a genre, a rating, a date, or a combination thereof.

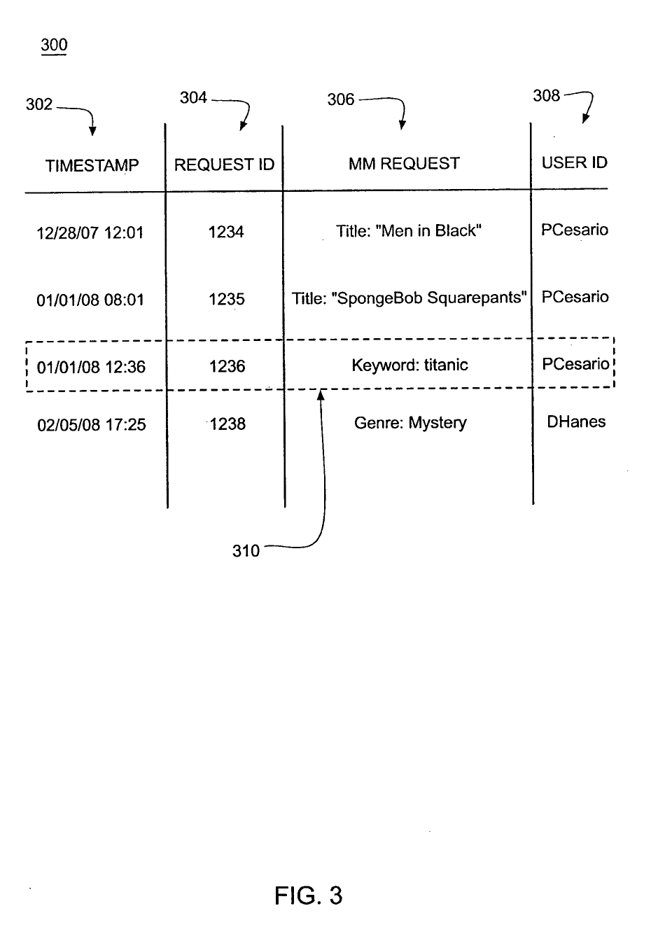

FIG. 3 is a representation of a collection 300 of multimedia file requests 112 as stored in NAS device 104 according to an embodiment. Multimedia file requests 112 comprise a timestamp field 302, a request identifier (ID) field 304, a multimedia request field 306, and a user ID field 308. A particular multimedia file request 310 is identified using a dashed-line box and comprises a date value in timestamp field 302, an identifier value in request ID field 304, a keyword-based request in multimedia request field 306, and a user identifier value in user ID field 308.

As depicted, collection 300 comprises multimedia file requests 112 arranged in date order based on values in timestamp field 302 of the requests. In at least some embodiments, collection 300 may be sorted on one or more fields of the multimedia file requests.

Returning to FIG. 1, user NAS 104 comprises a storage medium such as a hard drive in combination with a processing device. User NAS 104 also comprises memory for storing instructions for execution by the processing device. NAS device 104 is configured as a network attached storage device which comprises functionality for communicating with other user devices, such as general purpose computer systems, and with media server 102. NAS 104 is accessed by user devices for storing and retrieving files and transmits requests and receives files from media server 102.

NAS device 104, in at least one embodiment, is a self-contained processing device connected to a network such as a user's home network, with the sole purpose of supplying file-based data storage services to other devices on the network. Operating system and other software on NAS 104 provide the functionality of data storage, file system, and access to files, and the management of such functionalities. In at least some embodiments, NAS 104 is not designed to carry out general-purpose computing tasks. In at least some embodiments, NAS 104 does not have a keyboard or display, and is controlled and configured over the home network, e.g., by connecting a browser to the network address of NAS 104.

In at least some embodiments, NAS 104 does not contain a general-purpose operating system. In at least some embodiments, minimal-functionality or stripped-down operating systems are used to control NAS 104.

In at least one embodiment, NAS 104 contains one or more hard disks, often arranged into logical, redundant storage containers or RAID arrays (redundant arrays of inexpensive/independent disks).

In at least some embodiments, NAS 104 uses file-based protocols such as network file system (NFS) or server message block (SMB).

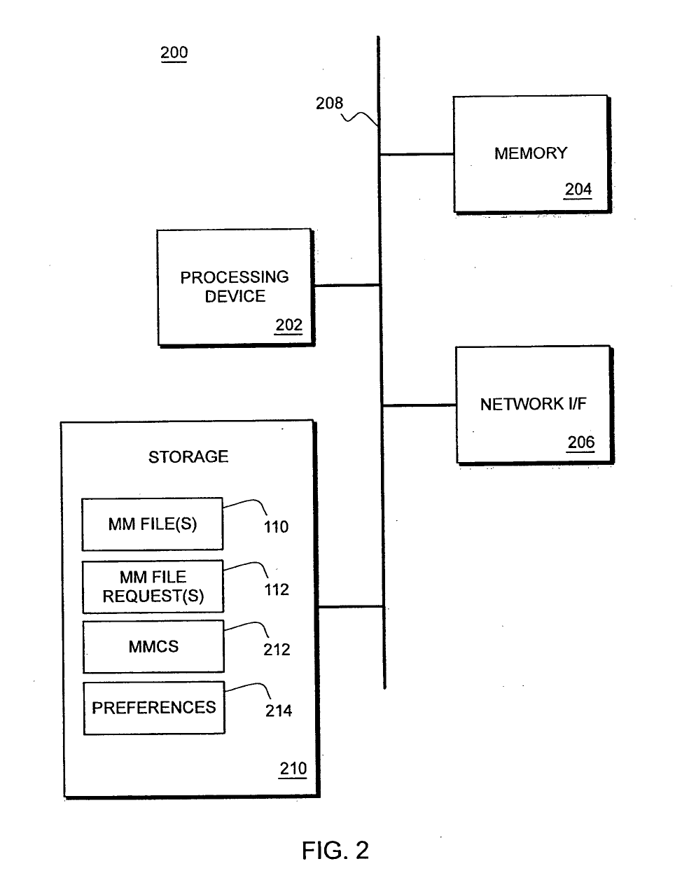

FIG. 2 depicts a high-level functional block diagram of an embodiment 200 of NAS 104 as a processing device for executing a set of instructions. Embodiment 200 comprises a processing device 202, a memory 204, and a network interface (I/F) device 206 each communicatively coupled with a bus 208. Memory 204 (also referred to as a computer-readable medium) is coupled to bus 208 for storing data, e.g., multimedia files and/or multimedia file requests, and instructions to be executed by processing device 202. Memory 204 also may be used for storing temporary variables or other intermediate information during execution of instructions to be executed by processing device 202. In at least some embodiments, memory 204 comprises one or more magnetic, optical, or charge-based data storage media, e.g., a hard disk, for storing multimedia files. Memory 204 may also comprise a read only memory (ROM) or other static storage device coupled to bus 208 for storing static information and instructions for processing device 202.

Network I/F device 206 may comprise at least one of a wired connection or a wireless connection for enabling communication with other networked devices, e.g., media server 102 via network 108.

NAS device 104 also comprises a storage device 210 such as one or more hard drives for storing multimedia files and file requests. In at least some embodiments, storage device 210 comprises a greater amount of storage than is present on a desktop computer system. In at least some embodiments, storage device 210 comprises a greater amount of storage than is present on a laptop and/or portable computer system. In at least some embodiments, storage device 210 comprises an amount of storage exceeding 1 Terabytes (TB). In at least some embodiments, storage device 210 comprises an amount of storage exceeding 2 TB. In at least some embodiments, storage device 210 comprises an amount of storage sufficient to store a plurality of movie files.

Storage device 210 stores zero or more multimedia files 110, zero or more multimedia file requests 112, a multimedia control system (MMCS) 212, and preferences 214.

Returning to FIG. 1, user home 106 also comprises a home network 114 communicatively coupling NAS 104 with a first controller 116 (“Controller 1”), in turn connected with a first display 118, and a second controller 120 (“Controller 2”), in turn connected with a second display 122.

In at least some embodiments, first controller 116 is a computer system, e.g., a general purpose computer system. First controller 116 drives a signal for displaying video on first display 118 and a signal for producing audio using speakers of first display 118. In at least some embodiments, first controller 116 drives a signal for producing audio using speakers separate from first display 118.

In at least one embodiment, first controller 116 comprises functionality for streaming a multimedia file from NAS device 104. During operation of streaming functionality, first controller 116 may be arranged to not store the streamed multimedia file for subsequent playback on first controller 116.

In at least some embodiments, second controller 120 is a specialized processing device for generating audio and video signals for a user, e.g., a media player such as a set-top box. Second controller 120 drives a signal for displaying video on second display 122 and a signal for producing audio using speakers of second display 122. In at least some embodiments, second controller 120 drives a signal for producing audio using speakers separate from second display 122. In at least some embodiments, second controller 120 comprises authentication functionality for authenticating a user of the device. In some embodiments, second controller 120 may be controlled by another device, e.g., first controller 116, and caused to play a specified multimedia file 110 from NAS 104.

In at least one embodiment, second controller 120 is configured to stream, i.e., not store for subsequent playback, a multimedia file from NAS device 104 via home network 114.

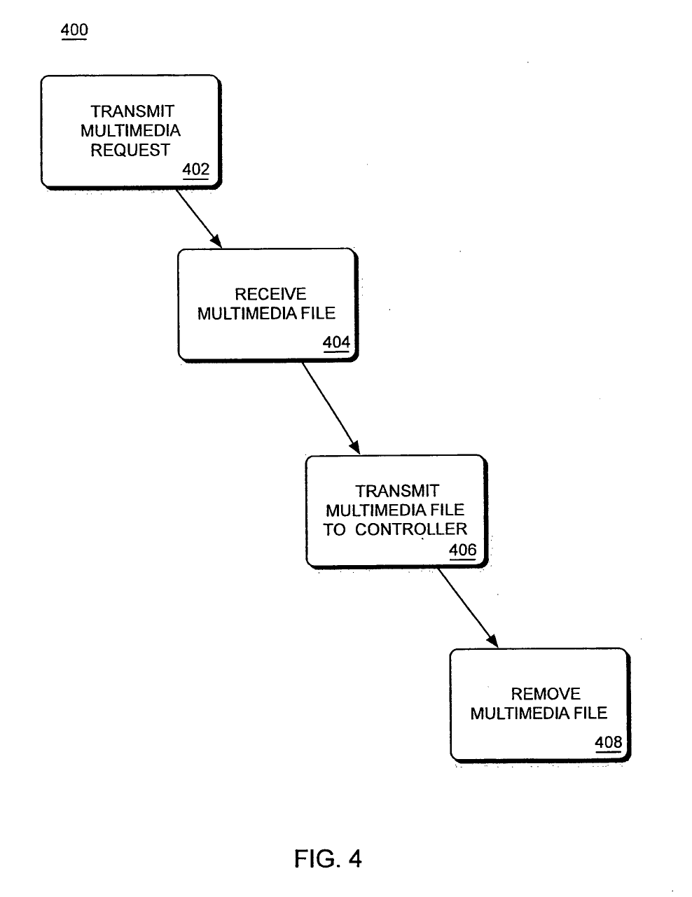

FIG. 4 is a high-level functional process flow of a multimedia file request and transmission functionality portion 400 of MMCS 212 according to an embodiment. Portion 400 comprises a set of instructions for execution by processing device 202 to cause the processing device to perform the functionality specified by FIG. 4.

The process flow begins at transmit request functionality 402 wherein processing device 202 executes a set of instructions which cause the processing device to transmit a multimedia file request 112 to media server 102 via network 108. In at least some embodiments, request functionality 402 is executed responsive to receipt of one or more multimedia file requests 112 from a user via a controller, e.g., first controller 116 or second controller 120. In at least some embodiments, request functionality 402 is executed responsive to a predetermined time period expiration, i.e., on a predetermined scheduled basis. In at least some embodiments, request functionality 402 is executed responsive to a manual user activation via a controller.

Processing device 202 responsive to execution of request functionality 402 transmits at least one multimedia file request 112, e.g., from collection 300, to media server 102. In at least some embodiments, request functionality 402 transmits at least one of a single MM file request 112, more than one MM file request, all MM file requests, a predetermined subset of MM file requests, or a combination thereof to media server 102. In at least some embodiments, request functionality 402 determines how many and/or which MM requests 112 to transmit based on preferences 214. In at least some embodiments, request functionality 402 stores information identifying whether and which MM file requests 112 have been transmitted and/or which requests have been fulfilled.

In at east some embodiments, request functionality 402 transmits a multimedia file request 112 at a predetermined time of day. In at least some embodiments, request functionality 402 transmits a multimedia file request 112 during a period of low or minimal communication activity with one or more controllers and/or media server 102. For example, the multimedia file requests may be transmitted late at night or early in the morning.

In at least some embodiments, request functionality 402 transmits a subset of the multimedia file requests 112 of collection 300 based on the user ID field 306, i.e., request functionality 402 transmits multimedia file requests 112 corresponding to a particular user.

In at least some embodiments, request functionality 402 may include as part of a transmitted multimedia file request a predetermined requested delivery period during which receipt of multimedia files from media server 102 is requested to occur. In at least some embodiments, the predetermined requested delivery period may be provided to media server 102 as a priori information.

After transmission of one or more MM file requests 112 to media server 102, the process flow proceeds to receive MM file functionality 404 wherein responsive to receipt of a multimedia file 110 processing device 202 receives the multimedia file and stores the file for subsequent access. In at least some embodiments, receive functionality 404 causes NAS device 104 to transmit an indication of receipt of multimedia file 110 to a controller, e.g., based on preferences 214. Also, in response to receipt of multimedia file 110, receive functionality 404 causes processing device 202 to update the status of the corresponding MM file request 112. In at least some embodiments, the received multimedia files 110 comprise attributes restricting the playback of a predetermined number of multimedia files. For example, a user may be restricted to viewing 100 movies a month, but only one movie at a time. According to another example, a user may be restricted to viewing 75 movies a month, with three being available to view at a given time. In at least some embodiments, the restrictive attributes for multimedia file viewing may be stored in preferences 214.

After receipt of one or more MM files 110, the process flow proceeds to transmit multimedia file functionality 406. During transmit file functionality 406, processing device 202 transmits a received MM file 110 to one or more controllers via a network 114. In at least one embodiment, processing device 202 transmits the received multimedia file 110 via a streaming protocol.

In at least some embodiments, processing device 202 awaits a request from a controller prior to transmitting the received multimedia file 110 to the requesting controller.

After completion of transmission of a multimedia file 110 to a controller, a process flow proceeds to remove file functionality 408. In at least some embodiments, the process flow may proceed to remove file functionality 408 responsive to user input, e.g., an indication from a user that the user has completed playback of a particular multimedia file. Responsive to completion of transmission, or receipt of appropriate user input via controller, remove file functionality 408 causes processing device 202 to mark the particular multimedia file as having been played back and remove the file from storage device 210. In at least some embodiments, remove file functionality 408 causes processing device 202 to mark the particular multimedia file as having been played back and as being available to be removed without actually removing the multimedia file. Subsequent to marking the file as being available to be removed, e.g., at a date and/or time or under other specified conditions from preferences 214, remove file functionality 408 causes removal of the multimedia file from storage device 210.

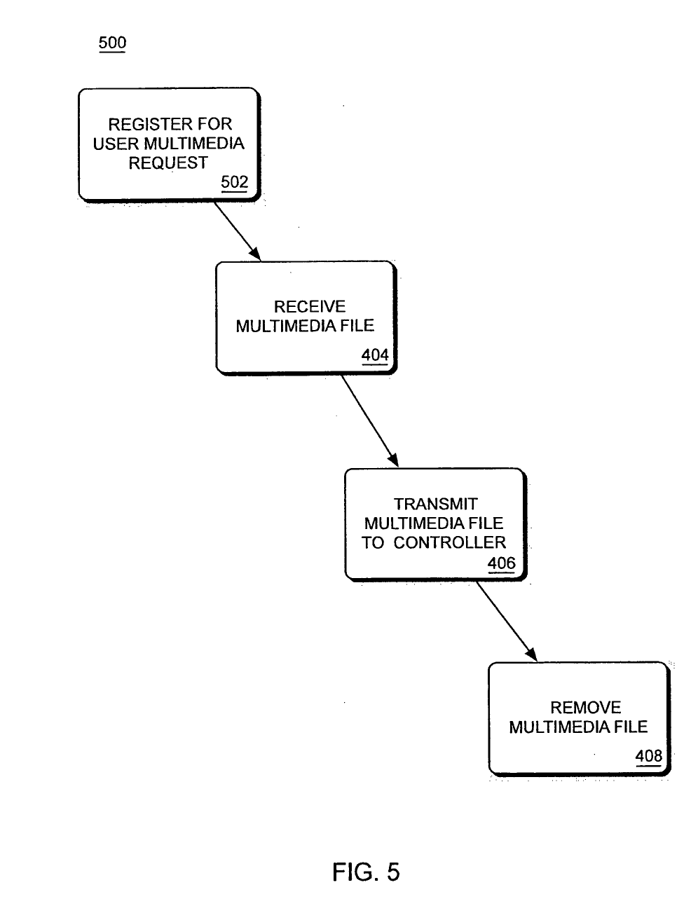

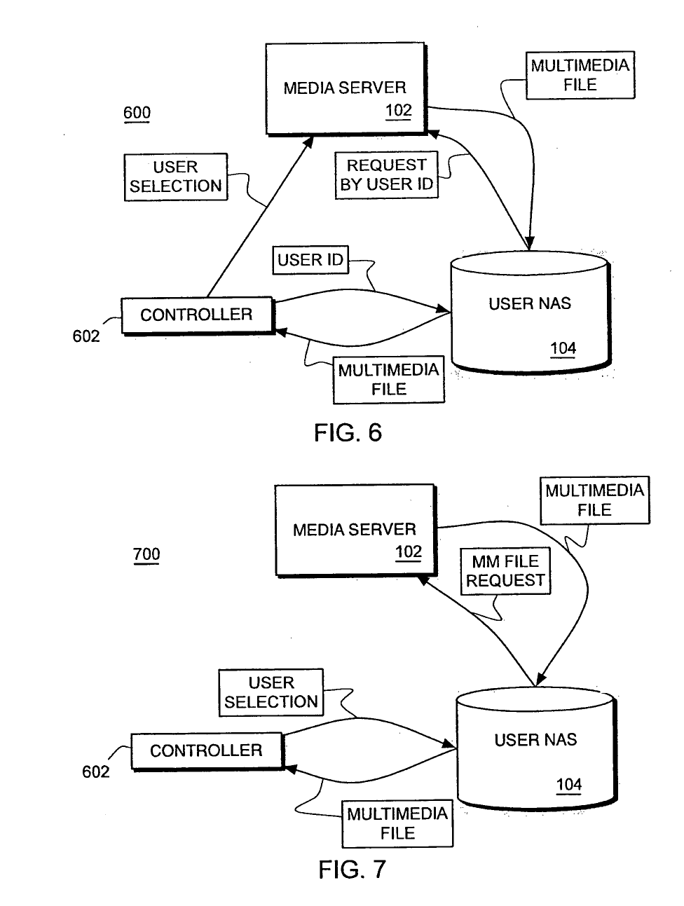

FIG. 5 is a high-level functional process flow of a registration and transmission functionality portion 500 of MMCS 212 according to another embodiment. Portion 500 comprises a set of instructions for execution by processing device 202 to cause the processing device to perform the functionality specified by FIG. 5. In accordance with the FIG. 5 embodiment, a user at a controller accesses media server 102 via network 114 and 108, e.g., the user accesses a web storefront provided by media server 102, and specifies one or more multimedia file requests 112. For example, the user accesses the web storefront to build a user specified selection of multimedia file requests 112 which specify one or more multimedia files 110 that the user desires to subsequently view on a controller. In accordance with this embodiment, the multimedia file request 112 is stored on media server 102 and not on NAS device 104.

The process flow begins at register for user multimedia request functionality 502 wherein the processing device 202 executes a set of instructions which cause the processing device to contact media server 102 and register to receive one or more multimedia files 110 corresponding to multimedia file(s) specified in the stored multimedia file requests 112 (stored on media server 102). In at least some embodiments, registration of NAS 104 with media server 102 comprises transfer of user subscription information, e.g., username and password, or other credential information, corresponding to the user from the NAS device to the media server. Subsequent to registration of NAS device 104 with a media server 102 according to register functionality 502, the process flow proceeds to receive file functionality 404 and continue execution in accordance with the above-described FIG. 4 embodiment. In at least some embodiments, receive file functionality 404 occurs based on at least one of receipt of user input, expiration of a periodic time period, a determination of idle time on NAS device 104, or a determination of low or minimal communication usage on NAS device 104. In at least some embodiments, NAS device 104 may signal to media server 102, based on one or more preferences 214, a particular time period during which multimedia files 110 are to be transmitted to the NAS device, e.g., late at night or early in the day.

FIG. 6 depicts a high-level functional information flow 600 between media server 102, user NAS 104, and a controller, i.e., either first controller 116 or second controller 120, according to an embodiment. For ease of explanation, network connections 108, 114 have been omitted. According to flow 600, a user manipulates controller 602 to cause the controller to transmit a user selection of a multimedia file to media server 102. In at least some embodiments, controller 602 may either receive or retrieve a catalog (or a portion thereof) of available multimedia files from media server 102 from which the user selects a multimedia file. In at least some embodiments, media server 102 stores the user selection as a multimedia file request 112.

Subsequent to the user selection being transmitted to media server 102, controller 602 communicates a user identifier (ID), or other mechanism for identifying the transmitted user selection to user NAS 104 at the media server, to the user NAS. Responsive to receipt of the user ID, user NAS 104 communicates with media server 102 in order to identify and request the corresponding multimedia file selected by the user at controller 602. That is, in at least some embodiments, user NAS 104 transmits a request for one or more multimedia files corresponding to the user ID to media server 102.

Responsive to receipt of the request from user NAS 104, media server 102 transmits one or more multimedia files to user NAS 104. In at least some embodiments, media server 102 may transmit a multimedia file 112 to user NAS 104 in accordance with one or more preferences 214 which may have been previously communicated to the media server or which may be communicated to the media server in conjunction with the request for a multimedia file. Responsive to receipt of the multimedia file from media server 102, and in accordance with the above-described functionality, user NAS 104 transmits the multimedia file to controller 602, i.e., either via partial or complete transfer or via streaming.

FIG. 7 depicts a high-level functional information flow 700 similar to information flow 600 (FIG. 6). According to flow 700, a user manipulates controller 602 to cause the controller to transmit a user selection of a multimedia file to user NAS 104. In at least some embodiments, controller 602 may either receive or retrieve a catalog (or a portion thereof) of available multimedia files from user NAS 104 from which the user selects a multimedia file. In at least some embodiments, user NAS 104 may proxy requests received from controller 602, e.g., requests for the catalog (or a portion thereof), and request further information as appropriate from media server 102 in order to satisfy the request. For example, user NAS 104 may cache a portion of a multimedia file catalog from media server 102. In at least some embodiments, user NAS 104 stores the user selection as a multimedia file request 112.

Subsequent to the user selection being transmitted to user NAS 104, user NAS 104 communicates with media server 102 in order to request the corresponding multimedia file selected by the user at controller 602 (“MM file request”).

Responsive to receipt of the request from user NAS 104, media server 102 transmits one or more multimedia files to user NAS 104. In at least some embodiments, media server 102 may transmit a multimedia file 112 to user NAS 104 in accordance with one or more preferences 214 which may have been previously communicated to the media server or which may be communicated to the media server in conjunction with the request for a multimedia file. Responsive to receipt of the multimedia file from media server 102, and in accordance with the above-described functionality, user NAS 104 transmits the multimedia file to controller 602, i.e., either via partial or complete transfer or via streaming. In at least some embodiments, user NAS 104 delays transmission of the multimedia file request 112 until a predetermined condition is met, e.g., idle time on user NAS 104, a particular time of day, a threshold communication traffic level, etc.

The functions of a method described in connection with the embodiments disclosed herein may be embodied in hardware, software, or a combination thereof. Software comprising instructions for execution may reside in a computer-readable medium comprising volatile and/or non-volatile memory, e.g., a random access memory, a read only memory, a programmable memory, a hard disk, a compact disc, or another form of storage medium readable, directly or indirectly, by a processing device.

What is claimed is:

1. A network attached storage (NAS) device 104 for multimedia file distribution comprising:
a processing device 202;
a network interface 206 connected with the processing device 202; and
a storage device 210 connected with the processing device 202, the storage device 210 comprising:
a set of predetermined multimedia file requests 112;
a set of multimedia files 110; and
a set of executable instructions 212 which, when executed by the processing device 202, cause the processing device 202 to transmit one or more requests from the set of predetermined multimedia file requests 112 to a media server 102 via the network interface 206; to receive one or more multimedia files 110 responsive to a transmitted one or more requests 112; to transmit one or more multimedia files 110 from the set of multimedia files 110 to one or more controllers 116, 120 via the network interface 206 for display to a user via a display 118, 122 connected with each of the one or more controllers 116, 120; and to remove one or more multimedia files 110 from the set of multimedia files 110 responsive to a predetermined file removal process.

2. The device as claimed in claim 1, wherein the NAS device 104 is arranged to solely supply file-based data storage services.

3. The device as claimed in claim 1, wherein the storage device 210 comprises greater than 1 Terabyte of storage space.

4. The device as claimed in claim 1, wherein instructions which cause the processing device 202 to transmit one or more multimedia files 110 to one or more controllers 116, 120 comprises instructions to cause the processing device 202 to stream the one or more multimedia files 110 to the one or more controllers 116, 120.

5. The device as claimed in claim 1, wherein the one or more multimedia file requests 112 comprise one or more attributes comprising a user identifier 308 and zero of more of a request identifier 304, a title, a keyword, a date range, or a genre.

6. A network attached storage (NAS) device 104 for multimedia file distribution comprising:
a processing device 202;
a network interface 106 connected with the processing device 202; and
a storage device 210 connected with the processing device 202, the storage device 210 comprising:
a set of user registration information 214;
a set of multimedia files 110; and
a set of executable instructions 212 which, when executed by the processing device 202, cause the processing device 202 to transmit a set of user registration information 214 to a media server 102 via the network interface 106; to receive one or more multimedia files 110 responsive to the transmitted user registration information 214; to transmit one or more multimedia files 110 from the set of multimedia files 110 to one or more controllers 116, 120 via the network interface 106 for display to a user via a display 118, 122 connected with each of the one or more controllers 116, 120; and to remove one or more multimedia files 110 from the set of multimedia files 110 responsive to a predetermined file removal process.

7. The device as claimed in claim 6, wherein the multimedia file 110 comprises rights management information restricting playback of the multimedia file 110.

8. The device as claimed in claim 6, wherein the storage device 210 comprises a set of preferences 214 storing user subscription information.

9. A method of distributing multimedia files 110 comprising:
transmitting at least one of a request from a set of predetermined multimedia file requests 112 or a set of user registration information 214 to a media server 102 via a network interface 106;
receiving at least one of one or more multimedia files 110 responsive to the transmitted request 112 or one or more multimedia files 110 responsive to the transmitted user registration information 214;
transmitting one or more multimedia files 110 from the set of multimedia files 110 to one or more controllers 116, 120 via the network interface 106 for display to a user via a display 118, 122 connected with each of the one or more controllers 116, 120; and
removing one or more multimedia files 110 from the received one or more multimedia files 110 responsive to a predetermined file removal process.

10. The method as claimed in claim 9, wherein the transmitting a request occurs based on at least one of a user input, a periodic timeout, a determination of idle time, or a determination of low communication usage rate.
